(19) United States
(12) Patent Application Publication
(10) Pub. No.: US 2023/0413854 A1
(43) Pub. Date: Dec. 28, 2023

(54) METHOD OF PREPARING A VEGAN SALMON ANALOGUE

(71) Applicant: SOCIETE DES PRODUITS NESTLE S.A., Vevey (CH)

(72) Inventors: OLIVER NUSSLI, Oberdorf, NJ (US); SYLVIE JOELLE MERINAT, Venthone (CH); YU-JIE WANG, Lausanne (CH); KATHARINA HINRICHS, Stuttgart (DE)

(21) Appl. No.: 18/042,030

(22) PCT Filed: Aug. 19, 2021
(86) PCT No.: PCT/EP2021/073084

§ 371 Date: Feb. 17, 2023

(30) Foreign Application Priority Data
Aug. 20, 2020 (EP) 20192028.7

(51) Int. Cl. A23J 3/22; A23L 33/185; A23J 3/14; A23L 29/244; A23L 33/21; A23L 29/256; A23L 33/16; A23P 20/20

(52) U.S. Cl. CPC A23J 3/227; A23L 33/185; A23J 3/14; A23P 20/20; A23L 33/21; A23L 29/256; A23L 33/16; A23L 29/244

(57) ABSTRACT

The invention relates to a method of making a vegan salmon analogue, said method comprising hydrating a mixture comprising a plant protein source, a glucomannan source, a carrageenan source; heating the mixture to extract soluble fibers from glucomannan and carrageenan; optionally adding flavors, oil, and colors; cooling the mixture to form a first layer having a viscosity of at least 1900 mPa·s; optionally applying a second layer comprising an insoluble fiber source and a calcium salt on the surface of the first layer.

### CROSS REFERENCE TO RELATED APPLICATIONS

The present application is a National Stage of International Application No. PCT/EP2021/073084, filed on Aug. 19, 2021, which claims priority to European Patent Application No. 20192028.7, filed on Aug. 20, 2020, the entire contents of which are being incorporated herein by reference.

### INTRODUCTION

Overfishing is a major threat to marine fish stocks worldwide. The World Economic Forum estimated that 90% of the world's stocks were either fully exploited, overexploited or depleted in 2018.

In terms of public health, there is also a growing awareness and concern about the accumulation of heavy metals and microplastics in fish. About 2% of the global population are thought to suffer from sea food allergies.

If consumers were encouraged to make the switch to fish analogues, this could help to address the sustainability and public health issues. One of the most popular types of fish is salmon which is enjoyed in many countries. Salmon analogue products do exist but they are generally of very low quality and lack the taste, texture, and nutrition of real salmon.

There is a clear need to provide consumers with salmon analogue products which address the sustainability and public health issues, and which more closely resemble the qualities of real salmon.

### SUMMARY OF INVENTION

The inventors have developed a method for cold-set gelation of fibres to form viscoelastic and translucent gels which mimic raw fishlike texture and appearance. Specific combinations of insoluble fibres and minerals are used to create a white layer to mimic that seen in raw salmon. Selected proteins, fibres, salt, and a process for gel texture modulation are also used to mimic the fishlike in-mouth melting perception.

Accordingly, the invention relates to a method of preparing a fish analogue, said method comprising the steps of hydrating a mixture comprising a glucomannan source and a carrageenan source; heating and then cooling the mixture.

In particular, the method comprises hydrating a mixture comprising a plant protein source, a glucomannan source, and a carrageenan source; heating the mixture; optionally adding flavors, oil, and colors; and cooling the mixture to form a first layer.

In particular, the invention relates to a method of preparing a salmon analogue, said method comprising the steps
a. Hydrating a mixture comprising a plant protein source, a glucomannan source, a carrageenan source, and a potassium salt;
b. Heating the mixture;
c. Optionally adding flavors, oil, and colors;
d. Cooling the mixture to less than 80° C. to form a first layer;
e. Optionally applying a second layer comprising an insoluble fiber source and a calcium salt on the surface of the first layer.

In particular, the invention relates to a method of preparing a salmon analogue, said method comprising the steps
a. Hydrating a mixture comprising a plant protein source, a glucomannan source, a carrageenan source, and a potassium salt;
b. Heating the mixture;
c. Optionally adding flavors, oil, and colors;
d. Cooling the mixture to less than 80° C. to form a first layer having a viscosity of at least 1900 mPa s;
e. Optionally applying a second layer comprising an insoluble fiber source and a calcium salt on the surface of the first layer.

In particular, the method comprises hydrating a mixture comprising a plant protein source, a glucomannan source, a carrageenan source; heating the mixture to extract soluble fibers from glucomannan and carrageenan; optionally adding flavors, oil, and colors; cooling the mixture to form a first layer having a viscosity of at least 1900 mPa s; optionally applying a second layer comprising an insoluble fiber source and a calcium salt on the surface of the first layer.

In particular, the invention relates to a method of preparing a salmon analogue, said method comprising the steps
a. Hydrating a mixture comprising a plant protein source, a glucomannan source, a carrageenan source, and a potassium salt;
b. Heating the mixture;
c. Optionally adding flavors, oil, and colors;
d. Cooling the mixture to less than 80° C. to form a first layer;
e. Optionally applying a second layer comprising an insoluble fiber source and a calcium salt on the surface of the first layer.

In some embodiments, the mixture is heated so that soluble fibers are extracted from glucomannan and carrageenan.

In some embodiments, the first layer comprises up to 10 wt % plant protein source, for example between 0.5 to 10 wt %, or 0.5 to 7 wt %.

In some embodiments, the plant protein source is selected from soy protein, whey protein, microalgae, and mycoprotein. The preferred protein source is soy protein.

In some embodiments, the carrageenan source and the glucomannan source are present in a ratio of about 1:1.25. The addition of glucomannan to single karrageenan gels can improve gel strength especially gel elasticity many times over. Gel syneresis can be reduced by glucomannan.

In some embodiments, the first layer comprises between 0.3 to 1 wt % carrageenan source, for example about 0.4 wt % carrageenan.

In some embodiments, the first layer comprises between 0.5 to 1.5 wt % glucomannan source.

In some embodiments, the glucomannan source is konjac glucomannan.

In some embodiments, the first layer further comprises a fibre source, for example potato fibre.

In some embodiments, the first layer further comprises sodium chloride (NaCl), preferably about 2 wt % NaCl.

In some embodiments, the mixture in step (i) is hydrated for at least 30 minutes, preferably at least 60 minutes.

In some embodiments, the mixture in step (i) is hydrated with water, milk, or a weak brine solution.

In some embodiments, the mixture in step (ii) is pH 6 or greater.

In some embodiments, the mixture in step (ii) is heated to at least 75° C., preferably to a temperature of between 75 to 90° C., preferably for about 20 minutes.

In some embodiments, the mixture in step (ii) is cooled to about 4° C. for 1 hour.

In some embodiments, the mixture is cooled to less than 80° C. to form a first layer having a viscosity of at least 1900 mPa-s.

In some embodiments, the insoluble fiber source in the second layer comprises over 80 wt % insoluble fiber.

In some embodiments, the insoluble fiber source is bamboo fiber, wheat fiber, oat fiber, cellulose powder, or mixtures thereof, preferably bamboo fiber.

In some embodiments, the insoluble fibre source in the second layer has a D90 particle size between 60 to 200 μm.

In some embodiments, the calcium salt in the second layer is calcium carbonate, calcium sulphate, calcium phosphate or tricalcium citrate, preferably calcium carbonate.

The invention also relates to a salmon analogue prepared by the method as described herein.

The invention also relates to a salmon analogue comprising a first layer, wherein the first layer comprises denatured plant protein, a glucomannan source, a carrageenan source, and a potassium salt.

The invention also relates to a salmon analogue comprising a first layer and a second layer, wherein the first layer comprises denatured plant protein, a glucomannan source, a carrageenan source, a potassium salt, and the second layer comprises a fiber source and a calcium salt. The salmon analogue of the invention is preferably devoid of animal products.

In some embodiments, said salmon analogue comprises less than 1% wt % fat.

In some embodiments, said salmon analogue comprises omega 3 fatty acids, preferably decosahexanoic acid.

In some embodiments, said salmon analogue comprises greater than 1.5 g fibre per 100 g.

In some embodiments, said salmon analogue comprises less than 30 calories per 100 g.

In some embodiments, the plant protein source is denatured, hydrolyzed, and/or homogenized.

### Definitions

As used herein, the singular forms “a,” “an” and “the” include plural referents unless the context clearly dictates otherwise. Thus, for example, reference to “an insoluble fiber source” or “the insoluble fiber source” includes two or more insoluble fiber sources.

The words “comprise,” “comprises” and “comprising” are to be interpreted inclusively rather than exclusively. Likewise, the terms “include,” “including” and “or” should all be construed to be inclusive, unless such a construction is clearly prohibited from the context.

The compositions disclosed herein may lack any element that is not specifically disclosed. Thus, a disclosure of an embodiment using the term “comprising” includes a disclosure of embodiments “consisting essentially of and “consisting of the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified.

The term “and/or” used in the context of “X and/or Y” should be interpreted as “X,” or “Y,” or “X and Y.” Where used herein, the terms “example” and “such as,” particularly when followed by a listing of terms, are merely exemplary and illustrative and should not be deemed to be exclusive or comprehensive. Any embodiment disclosed herein can be combined with any other embodiment disclosed herein unless explicitly stated otherwise.

As used herein, “about” and “approximately” are understood to refer to numbers in a range of numerals, for example the range of −10% to +10% of the referenced number, preferably within −5% to +5% of the referenced number, more preferably within −0.1% to +1% of the referenced number, most preferably within −0.1% to +0.1% of the referenced number.

As used herein, a product “substantially devoid” of an ingredient means that none of that ingredient is added as such to the product, and that any of the ingredient present originates from minor traces or impurities present in other ingredients.

A vegan product is defined as being devoid of animal products, for example devoid of dairy products and meat products. A vegan salmon analogue product of the invention has the look, taste, and texture which is close to real salmon.

The invention will now be illustrated by way of examples, which should in no way be thought to limit the scope of the invention as herein described.

### EXAMPLES

### Example 1

Development and Textural Analysis of Base Gel

A base gel was developed by combining K-carrageenan (KC), konjac glucomannan (KGM), potato fiber (PF), potassium chloride (KCl), sodium chloride (NaCl) and water. In order to develop a base gel with properties close to salmon texture and to understand the role of specific ingredients in the gel system, different concentrations and combinations of ingredients were tested. Formulations were made for single polysaccharide gels (one gelling agent) as well as for mixed polysaccharide gels (two gelling agents) by using polysaccharides/fibres (KC, KGM, PF), minerals (KCl, NaCl) and water either natural mineral water Vittel or MilliQ water. Table 1 shows the formulation in [wt %] for single polysaccharide gels (termed 0.4 KC, 0.8 KC, 0.4 KC_0.4 KCl) and mixed polysaccharide gels (termed KC/KGM) and base gel with and without NaCl (KC: K-carrageenan, KGM: konjac glucomannan, PF: potato fiber, KCl: potassium chloride, NaCl: sodium chloride)

TABLE 1

| | Gel name | | | | |
|---|---|---|---|---|---|
| | | | 0.4 KC_0.4 | | |
| | 0.4 KC | 0.8 KC | KCl | KC/KGM | Base Gel |
| Material | [wt %] | [wt %] | [wt %] | [wt %] | [wt %] |
| KGM | — | — | — | 0.5 | 0.5 |
| KC | 0.4 | 0.8 | 0.4 | 0.4 | 0.4 |
| PF | — | — | — | — | — |
| NaCl | 2.0 | 2.0 | 2.0 | 2.0 | 2.0 |
| KCl | 0.3 | 0.3 | 0.4 | 0.3 | 0.3 |
| H₂O | 97.3 | 96.9 | 97.2 | 96.8 | 96.4 |
| SUM | =100.0 | =100.0 | =100.0 | =100.0 | =100.0 |

All gels were prepared in Thermomix TM6. Dry ingredients were dispersed and hydrated in water for 60 min at room temperature followed by 15 min heating at 85° C.

To ensure a homogenous distribution of the ingredients and temperature, the formulation was stirred during the whole process at level 1 of the Thermomix. The introduction of air due to stirring was minimized. After heating, the high viscous hot mixture was molded into appropriate containers (squared plastic boxes for texture analysis, 50 ml falcon tubes for texture profile analysis, round glass molds for syneresis test and microscopy), leaving them to cool at room temperature for at least 3 h. Afterwards they were stored covered in fridge at 6° C. until their respective analysis.

Texture Analyzing Methods

The texture of the gels was characterized by destructive instrumental texture analysis (TA) and by non-destructive instrumental texture profile analysis (TPA). Both performed by TA-XT2 Texture Analyzer (Stable Micro Systems, Surrey, England) with a 5 kg load cell. The instrument was controlled by a computer using the software EXPONENT Connect Version 7.0.3.0 that allows test setup as well as data analysis via test specific macros analyzing force distance curves (TA) or force time curves (TPA).

Destructive TA was done with two different probe geometries resulting in a cutting (CUT) and penetration test (PEN). The cutting test was performed with a single blade 20 HDP/BS and its corresponding slotted base, while penetration was done by a cylindrical probe P/6 (Ø6 mm) and an un-slotted, normal base. As a sample geometry a 30 mm wide and 20 mm high cuboid was used.

For TPA a cylindrical probe (Ø45 mm) was used to perform two 30% compression cycles on a cylindrical sample of 15 mm height and 20 mm diameter with a pause of 25 5 s between the two compression cycles. By touching the sample surface, data recording started for all tests at a trigger force of 0.05 N.

Table 2 shows the probe and sample geometry and test parameters for CUT test, PEN test and TPA with 30% compression. Samples were analyzed with each method at least in double within more than 6 replicates per sample.

TABLE 2

| | | | | | TPA (non- | |
|---|---|---|---|---|---|---|
| | TA (destructive) | | | | destructive)Test | |
| Test | CUT | | PEN | | 30% Compensation | |
| Probe | Blade HDP/BS | | Cylinder | | Cylinder | |
| | | | (Ø 6 mm) | | (Ø 45 mm) | |
| Sample | Cuboid | | Cuboid | | Cylinder | |
| | (30 mm × | | (30 mm × 20 mm) | | (1.5 mm × | |
| | 20 mm) | | | | Ø 25 mm) | |
| Pre-test | 1.0 | mm/s | 1.0 | mm/s | 2.0 | mm/s |
| speed | | | | | | |
| Test speed | 1.0 | mm/s | 1.0 | mm/s | 2.0 | mm/s |
| Post-test | 10.0 | mm/s | 10.0 | mm/s | 5.0 | mm/s |
| speed | | | | | | |
| Distance | 10 | mm | 15 | mm | 4.5 | mm |

| Trigger force | 0.05N | 0.05N | 0.05N | |
|---|---|---|---|---|
| Number of | — | — | 2 | |
| cycles | | | | |
| Time | — | — | 5 | s |
| between | | | | |
| cycles | | | | |

Destructive TA

An example of a typical force-distance curve that resulted of either CUT or PEN test was made. Curves showed increasing force over distance, till a peak was reached, followed by a harsh decrease in force. The peak corresponded to gel breakage. The following values obtained from curve analysis help to define gel texture: “Hardness” defines the peak force, that is needed to break the gel, while “deformation” describes the distance of the probe at its breaking point. The area beneath the curve till the maximum is reached, describes the energy that is needed to break the gel and is called therefore “gel strength”. Rigidity defines the slope from starting point to the peak force.

Texture Profile Analysis

In contrast to TA, where force application on sample happens only once, Texture Profile Analysis (TPA) uses repeated compression cycles to include the level of recovery of the sample. Seven basic textural parameters (fracturability, firmness, adhesiveness, cohesiveness, gumminess, springiness and chewiness) can be taken from a recorded force-time curve of TPA measurement. By this, a bridge between the instrumental and sensory evaluation of texture could be served.

Cohesiveness

Cohesiveness is the dimensionless ratio of the positive peak area in the second circle (d+e) and the positive peak area in the first cycle (a+b). It measures how well the sample withstands the second compression relative to resistance under the first compression. If cohesiveness=1, the sample structure was able to regenerate completely during the pause between the two cycles, meaning that the sample could regain its strength as well as its resistance and withstand the second deformation as well as the first one. In contrast, a cohesiveness <1 expresses a partly irrecoverable deformation in the first cycle, that is followed by lower resistance in the second cycle.

Gumminess

Gumminess is the product of cohesiveness and hardness. It describes the energy needed to disintegrate a semi-solid food until it can be swallowed.

Springiness

Springiness is the quotient of distance 2 and distance 1, representing the deformation due to the downstroke in the two compression cycles. The ratio corresponds to the degree of which the sample returns relative to its original height after compression, which means it describes the ability of the material to get compressed and recovers to its original height. Equal distances are synonymous with perfect recovery to original height.

Resilience

Resilience is defined by the area of the first upstroke (area b) relative to the area of the first downstroke (area a). It describes how much the sample retaliates to regain its original shape and size, in other words it is the degree to which the sample returns the probes energy after the downstroke. It expresses the elasticity of the sample including

not only the distance, but also force and speed with which the sample fights against the initial deformation. Resilience=1 will mean that all the work given by the probe into the sample during the downstroke, is returned by the sample during the upstroke. Whereas resilience<1 is equivalent to an incomplete recovery in terms of either thickness (height) or less force or speed in comparison to the compression.

To compare textural and visual properties of the gels with a real animal benchmark, raw salmon filets were purchased from a local supermarket. High quality, skin and boneless back loin fillets of 180 g from Norwegian west coast were chosen for texture analysis. For textural analysis, pieces with the same dimensions as the gel samples where cut from the salmon fillets with the help of a knife or a cookie cutter (Ø2.5 cm).

Four salmon filets were analyzed with each method in four-fold replication. The nutritional values (in g/100 g) for raw salmon fillet were as follows: Protein (wet basis): 20 g, Fat: 16 g, Carbohydrate 0 g, Ash: 0 g. Gel preparations were done for all experiments at least as duplicates. Data is expressed as means t standard deviation.

If necessary, data was subjected to one-way analysis of variance (ANOVA) and Tukey post-hoc test, where significance of difference was defined for both at P<0.05.

Tests showed that K-carrageenan (KC) is considered suitable as main gelling agent in the system. As starting point a gel (termed 0.4 KC) with 0.4 wt % KC, 0.3 wt % KCl, and 2.0 wt % NaCl was defined. To study the impact of the salt on the gel strength, two variates of the initial gel were investigated: one containing 0.8 wt % KC, keeping KCl constant at 0.3 wt % (termed 0.8 KC), and the other keeping KC at 0.4 wt % but increasing the KCl content to 0.4 wt % (termed 0.4 KC_0.4 KCl). For all three gels the NaCl content remains constant at a level of 2 wt %. One day after preparation, gel texture was analyzed by different texture analyzing methods (CUT, PEN, TPA). Results are shown in Table 3, giving the mean value of the textural parameters obtained from the force-deformation (CUT, PEN) and the force-time (TPA) curves that were recorded during the texture analysis and the mean values for syneresis. One can observe that the cylindrical probe (PEN), the blade probe (CUT) and 30% compression (TPA) showed significantly higher values (P <0.05) for all parameters when the KC concentration is doubled from 0.4% to 0.8%. Gel strength and hardness are more than three times higher for doubling the KC concentration, while firmness doubled. Increase of deformation as well as resilience, cohesiveness and springiness (TPA) showed smaller increase reaching from 4-50%. To conclude, the doubling of gelling agent concentration increases gel hardness, that means a higher force is necessary to break it. Furthermore, the gel becomes more elastic i.e. increased deformation, cohesiveness, resilience springiness, gumminess. However, gel hardness increases more than gel elasticity for higher KC concentrations.

For the increase of KCl content from 0.3% to 0.4% at constant KC concentration of 0.4%, significant increment is only observable for destructive methods PEN and CUT in a much lower range of at least 20%, while parameters of non-destructive TPA do not change significantly (P<0.05).

Compression tests (TPA) are therefore less sensitive for small alterations of recipe than destructive methods. At higher KC content more helices are present that aggregate upon cooling, forming a denser network, while higher KCl concentration provides more material to connect a certain number of helices. Both enhances gel strength on one hand, but on the other hand extended cross-linking leads to reduced chain flexibility corresponding to brittle character of the gel, and the fact that deformation does not increase in the same degree as hardness.

TABLE 3

| Gel name | | | | | |
|---|---|---|---|---|---|
| KCI concentration | | | 0.4 KC | 0.8 KC | 0.4 KC_0.4 KCl |
| Test | Parameter | [wt %] | 0.3 | 0.3 | 0.4 |
| PEN | Hardness | [N] | 0.48 ± 0.02 a | 1.6 ± 0.06 b | 0.48 ± 0.03 a |
| | Deformation | [mm] | 3.1 ± 0.42 a | 4.4 ± 0.10 b | 3.6 ± 0.16 c |
| | Gel strength | [N-mm] | 0.71 ± 0.11 a | 2.6 ± 0.08 b | 0.84 ± 0.08 c |
| | Rigidity | [N/mm] | 0.14 ± 0.02 a | 0.35 ± 0.01 b | 0.12 ± 0.01 c |
| CUT | Hardness | [N] | 0.40 ± 0.05 a | 1.8 ± 0.41 b | 0.47 ± 0.04 c |
| | Deformation | [mm] | 2.2 ± 0.25 a | 3.4 ± 0.58 b | 2.7 ± 0.13 c |
| | Gel strength | [N-mm] | 0.45 ± 0.08 a | 3.0 ± 0.29 b | 0.59 ± 0.06 c |
| | Rigidity | [N/mm] | 0.14 ± 0.02 a | 0.50 ± 0.04 b | 0.15 ± 0.01 a |
| TPA | Firmness | [N] | 5.5 ± 0.71 a | 12.2 ± 0.66 b | 5.2 ± 0.47 a |
| | Resilience | [%] | 25.5 ± 2.8 a | 32.3 ± 1.7 b | 25.5 ± 2.0 a |
| | Cohesiveness | [%] | 51.8 ± 5.9 a | 63.8 ± 2.0 b | 51.3 ± 3.5 a |
| | Gumminess | [N] | 2.9 ± 0.35 a | 7.9 ± 0.27 b | 2.7 ± 0.15 a |
| | Springiness | [%] | 87.5 ± 0.97 a | 91.3 ± 2.4 b | 86.3 ± 1.3 c |

Different letters (a, b, c) in the same row indicate significant differences between means ± sd, n = 3). (P < 0.05).
(KC: K-carrageenan. KCl: potassium chloride).

Summarizing, this single polysaccharide gel from pure KC and ions is too weak and low in elasticity, or in reverse too brittle in comparison to salmon texture.

Referring to results from preliminary tests, konjac glucomannan was selected as 10 second polysaccharide to be added to the single KC gel, creating a mixed polysaccharide gel. For this mixed gel, the same analytical approach (textural analysis) was performed as for the single polysaccharide gels and compared with 0.4 KC gel. A significant increment for all textural parameters of PEN and CUT was recorded for the addition of 0.5 wt % KGM to 0.4 KC gel (termed hereafter KC/KGM gel) (Table 4). KC/KGM gel strength which represents the energy, that is necessary to break the gel by either penetration or cutting, rises from 0.71 N·mm to 15.3 N·mm (20 fold increment) (PEN) and 0.45 N-mm to 53.2 N-mm (CUT) (approx. 120 fold increment). In gel strength the increase of hardness and deformation is included, shifting gel properties to less brittleness. Whereas TPA parameter growth is less, showing a raise to maximal the 1.5 fold. Against that firmness, does not alter significantly by KGM addition.

TABLE 4

| Test | Parameter | | KC/KGM | KC/KGM/PF | Raw Salmon data |
|---|---|---|---|---|---|
| PEN | Hardness | [N] | 3.9 ± 0.35 a | 3.3 ± 0.33 b | 2.4 ± 0.62 c |
| | Deformation | [mm] | 10.3 ± 0.39 a | 10.0 ± 0.41 a | 11.7 ± 1.9 b |
| | Gel strength | [N-mm] | 15.3 ± 1.3 a | 14.0 ± 0.85 b | 15.2 ± 3.0 a |
| | Rigidity | [N/mm] | 0.37 ± 0.02 a | 0.4 ± 0.03 b | 0.23 ± 0.09 c |
| CUT | Hardness | [N] | 15.0 ± 0.77 a | 12.0 ± 1.6 b | 11.1 ± 2.5 b |
| | Deformation | [mm] | 12.0 ± 1.1 a | 12.2 ± 1.0 a | 13.3 ± 2.6 b |
| | Gel strength | [N-mm] | 53.2 ± 7.9 a | 45.1 ± 8.2 b | 56.7 ± 18.6 c |
| | Rigidity | [N/mm] | 1.2 ± 0.06 a | 1.0 ± 0.12 b | 0.88 ± 0.32 b |
| TPA | Firmness | [N] | 5.8 ± 0.57 a | 6.4 ± 0.66 b | 5.7 ± 1.1 c |
| | Resilience | [%] | 40.6 ± 2.0 a | 40.9 ± 3.8 a | 27.0 ± 5.6 b |
| | Cohesiveness | [%] | 73.8 ± 1.6 a | 72.9 ± 1.8 a | 46.5 ± 11.1 b |
| | Gumminess | [N] | 4.3 ± 0.4 a | 4.8 ± 0.38 b | 2.7 ± 0.78 c |
| | Springiness | [%] | 94.5 ± 0.6 a | 93.2 ± 1.6 b | 83.6 ± 6.0 c |
| SYN | Syneresis | [%] | 10.2 ± 0.4 a | 8.1 ± 1.0 b | |

Different letters (a, b, c) in the same row indicate significant differences between means (k ± sd, n = 3). (P < 0.05).
(KC: K-carrageenan. KGM: konjac glucomannan. PF: potato fiber).

This suggests that lower and more homogenously distributed non-destructive force application (30% compression) with a probe that is larger in diameter (45.0 mm) than the sample (25.0 mm), is again less sensitive for gel texture than the destructive methods, (confirming the results of single KC gel tests).

12

To sum up, the addition of KGM addition to the single KC gel can improve gel strength especially gel elasticity many times over. Additionally, gel syneresis can be reduced by KGM addition and further by potato fibre (PF) addition.

In order to evaluate and improve formulation, the gained textural data are compared

to real salmon (Table 4). Slightly lower TPA values for real salmon than for
KC/KGM/PF gel can be reported, except for cohesiveness and resilience, which amounted to only 65% of the respective gel values. For the parameters determined by CUT and PEN methods, comparable values were determined for real raw salmon and KC/KGM/PF gel, when taking standard deviation into account.

10 In summary, a gel system with a texture in the range of salmon texture could be established, by the mixture of multiple polysaccharides and ions at appropriate ratios. Chosen methods to analyse texture and syneresis test were able to differentiate between the differences in the gel, which enabled to understand the contribution of each ingredient to the overall texture of the gel. Gel hardness mainly derives from KC

and the cations, while elasticity and resistance against deformation is related to KGM, which reduces syneresis by viscosifying the system. PF contributes to binding water and reduces the translucency to an acceptable level. All chosen ingredients allowed to keep gel translucency, even though it decreased from completely transparent (KC) to translucent.

Although comparable values of textural parameters were found for fish texture and KC/KGM/PF gel texture, we realized that the developed mixed gels were too gummy and homogeneous in the sensory evaluation comparing to real raw salmon which is soft, creamy and melting in mouth.

### Example 2

Addition of Protein to Base Gel—Different Protein Sources and Concentrations

Protein gels were prepared based on different sources (soy, whey, microalgae, mycoprotein). Four soy protein concentrations were tested (1 wt %, 3 wt %, 5 wt %, 7 wt %). Protein gels with whey and microalgae were only prepared with addition of 3

wt % protein and mycoprotein was added at a level of 1.5 wt %. The lower concentration of mycoprotein was selected due to compositional reasons of this material (high in fiber content). Results from preliminary tests showed the addition of 3 wt % resulted in an overly high gel strength. Specifications and further description on the properties of the protein sources are given below. Table 5 shows the moisture content [wt %] and nutrient content [wt %] of different protein sources based on the supplier's specifications (Mycoprotein, Microalgae, WPH, WPI). Nutrient specification was given on wet basis and dry basis
of material (Microalgae: Chlorella vulgaris, WPI: whey protein isolate, WPH: whey protein hydrolysate).

TABLE 5

| | Mycoprotein | | Microalgae | | WPH | | WPI | |
|---|---|---|---|---|---|---|---|---|
| Protein type | [wt %] | | [wt %] | | [wt %] | | [wt %] | |
| Nutrient | wet | dry | wet | dry | wet | dry | wet | dry |
| Moisture | 75.0 | — | 6.0 | — | 5.0 | — | 4.6 | — |
| Protein | 11.3 | 45.0 | 65.0 | 69.1 | 83.0 | 87.4 | 92.8 | 97.3 |
| Fat | 3.3 | 13.0 | 14.0 | 14.9 | 0.2 | 0.2 | 0.7 | 0.7 |
| Carbohydrates | 3.0 | 12.0 | 18.0 | 19.1 | 0.1 | 0.1 | 0.1 | 0.1 |
| Dietary Fibre | 6.3 | 25.0 | 18.0 | 19.1 | — | — | — | — |
| Minerals | 0.9 | 3.4 | 13.0 | 13.8 | 6.0 | 6.3 | 1.9 | 2.0 |

Table 6 below shows the moisture content [wt %] and nutrient content [wt %] of different soy protein types (SPI_37, SPI_548, SPH). Nutrient specification given on wet basis and dry basis of material (SPI: soy protein isolate, SPH: soy protein hydrolysate)

TABLE 6

| | SPL_37 | | SPI_548 | | SPH | |
|---|---|---|---|---|---|---|
| Protein type | [wt %] | | [wt %] | | [wt %] | |
| Nutrient | wet | dry | wet | dry | wet | dry |
| Moisture | 4.5 | — | 4.9 | — | 5.0 | — |
| Protein | 91.3 | 95.6 | 93.7 | 98.5 | 80.0 | 84.2 |
| Fat | 1.0 | 1.0 | 1.0 | 1.1 | 0.5 | 0.5 |
| Carbohydrates | — | — | — | — | 5.0 | 5.3 |
| Dietary Fibre | — | — | — | — | — | — |
| Minerals | 5.5 | 5.8 | 5.5 | 5.8 | 9.0 | 9.5 |

Soy Protein

Different soy proteins were used. SPI_37 (Soy protein isolate SUPRO EX 37 HG IP-DuPont Nutrition Biosciences ApS,) is a functional soy protein that is recommended to provide texture and emulsion stability in a wide variety of meat systems. It has a clean neutral flavor profile and is described as very high viscous, high gelling and rapid setting. In comparison to SPI_37, the SPI SUPRO 548 IP (DuPont Nutrition Biosciences ApS) is low in viscosity and has medium to low gelling properties. Furthermore, it forms a more transparent gel than SPI_37. SPH (Soy protein hydrolysate ProDiem Refresh Soy 1307—Kerry Ingredients & Flavours Ltd) was produced from enzymatically treated soy protein isolate. It is soluble in water with a pleasant taste. A 10% solution has pH 4-5.

Whey Protein

Whey protein isolate (WPI) BIPRO® 9500 was used (Agropur Ingredients). Whey protein hydrolysate (WPH) Lacprodan® DI-3091 (Arta Foods Ingredients) is extensively hydrolyzed, with a high quantity of di- and tripeptides (DH 21-27%). It is 10 low in bitterness compared to hydrolysates of similar degree of hydrolysis. It is forwarded to use in neutral pH liquid applications.

Microalgae

For spray dried green microalgae Chlorella vulgaris powder with seaweed taste (Allmicroalgae) nutrient specifications were given in a range, as the composition varies according to growth condition. As protein content (wet basis) is specified to range between 54% and 65%, the middle (60%) was chosen as basis for the all subsequent calculations.

Mycoprotein

Mycoprotein is a single cell protein deriving from a filamentous fungi Fusarium venenatum and is produced by a continuous, axenic fermentation process, using a food grade carbohydrate substrate. Mycoprotein can be characterized as a source of high-quality protein, being low in fat and carbohydrates, but rich in fiber. Fat proportion consists mainly of unsaturated fatty acids, while fiber is mainly insoluble and composed of one-third chitin and two-thirds 33-glucans. ABUNDA® Mycoprotein Fulica 4F01 batch 6 was used (3F Bio™ Ltd).

Protein Gel Preparaton

Protein gels were prepared like the base gel (hydration, heating, molding), but with a prior mixture of protein and water (complete amount of water of the formulation) until the protein was dispersed (mixing time: −10 min), followed by the addition of the other dry ingredients starting hydration step as described for the base gel (60 min, room temperature). Mycoprotein does not dissolve in water and so a homogenization step with the Ultra Turrax T 25 basic (22.000 rpm/3 min), (IKA®-Werke GmbH & CO. KG) was added before hydration. In general, no pH adjustment of the protein dispersion was done after protein hydration, because preliminary tests showed neutral pH for both the base gel and the different protein gels, except SPH solution, which was acidic. As a consequence, SPH solution was neutralized to pH 7 by the addition of 4M NaOH under magnetic stirring at room temperature.

For all protein gels protein addition is expressed as a concentration like 3 wt % (based on protein content of the protein source) calculated as on top of the formulation of the base gel (which therefore equals 100%) to avoid the change of available water for gelling agents and salt due to protein addition in the base gel. In other words, the polysaccharide and ion to water ratio was kept constant. That will favor a better comparison of protein gels and base gel and help to investigate the direct impact of protein introduction into the system. An example of the formulation of protein gels is given in Table 7 for base gel (left column) and two base gel variants with reduced NaCl content. Formulation [wt %] for base gel (0%, 1%, 2% NaCl) with a protein addition is shown.

TABLE 7

| | Gel name | | |
|---|---|---|---|
| | NaCl concentration | | |
| | Base gel | Base gel_1% | Base gel_0% |
| | (2% NaCl) | NaCl | NaCl |
| Material | [wt %] | [wt %] | [wt %] |
| KGM | 0.5 | 0.5 | 0.5 |
| KC | 0.4 | 0.4 | 0.4 |
| PF | 0.4 | 0.4 | 0.4 |
| NaCl | 2.0 | 1.0 | — |
| KCl | 0.3 | 0.3 | 0.3 |
| H₂O | 96.4 | 97.4 | 98.4 |
| SUM | =100 | =100 | =100 |
| Additional protein | 1-7 | 1-7 | 1-7 |
| SUM | 101-107 | 101-107 | 101-107 |

Water amounts and protein powder addition for the formulations (to add on 100 g base gel) of the different protein gels and desired concentrations were calculated and adjusted for the final formulation of each protein (Tables 5 and 6), taking into account their specific moisture and protein content of the respective protein source. Table 8 shows adjusted formulations of water [g] and protein powder [g] for different protein gels (WPH, WPI, Mycoprotein, Microalgae) to maintain comparability to base gel. (indicated protein content [wt %] would be equivalent to 100% protein in the powders). (Microalgae: Chlorella vulgaris, WPI: whey protein isolate, WPH: whey protein hydrolysate)

TABLE 8

| | Gel name (protein type) | | | |
|---|---|---|---|---|
| | WPH[g] | WPI[g] | Mycoprotein[g] | Microalgae[g] |
| Protein content | 3.00 | 3.00 | 1.50 | 3.00 |
| [wt %] | | | | |
| H2O adjusted | 96.22 | 96.24 | 78.47 | 96.18 |
| Protein powder | 3.61 | 3.23 | 23.47 | 5.00 |

Table 9 shows adjusted formulations of water [g] and protein powder [g] for different protein gels (SPI_37, SPI_548, SPH) to maintain comparability to base gel. (indicated protein content [wt %] would be equivalent to 100% protein in the powders). (SPI: soy protein isolate, SPH: soy protein hydrolysate)

TABLE 9

| Gel name (protein type) | | |
|---|---|---|
| SPI_37 | SPI_548 | SPH |
| [g] | [g] | [g] |

1.00 wt % protein

| | | | |
|---|---|---|---|
| H₂O adjusted | 96.35 | 96.35 | — |
| Protein powder | 1.05 | 1.01 | — |

3.00 wt % protein

| | | | |
|---|---|---|---|
| H₂O adjusted | 96.26 | 96.25 | 96.21 |
| Protein powder | 3.14 | 3.04 | 3.75 |

5.00 wt % protein

| | | |
|---|---|---|
| H₂O adjusted | 96.16 | 96.15 |
| Protein powder | 5.23 | 5.07 |

7.00 wt % protein

| | | | |
|---|---|---|---|
| H₂O adjusted | 96.07 | 96.05 | 95.96 |
| Protein powder | 7.32 | 7.10 | 8.75 |

Protein Gel Texture

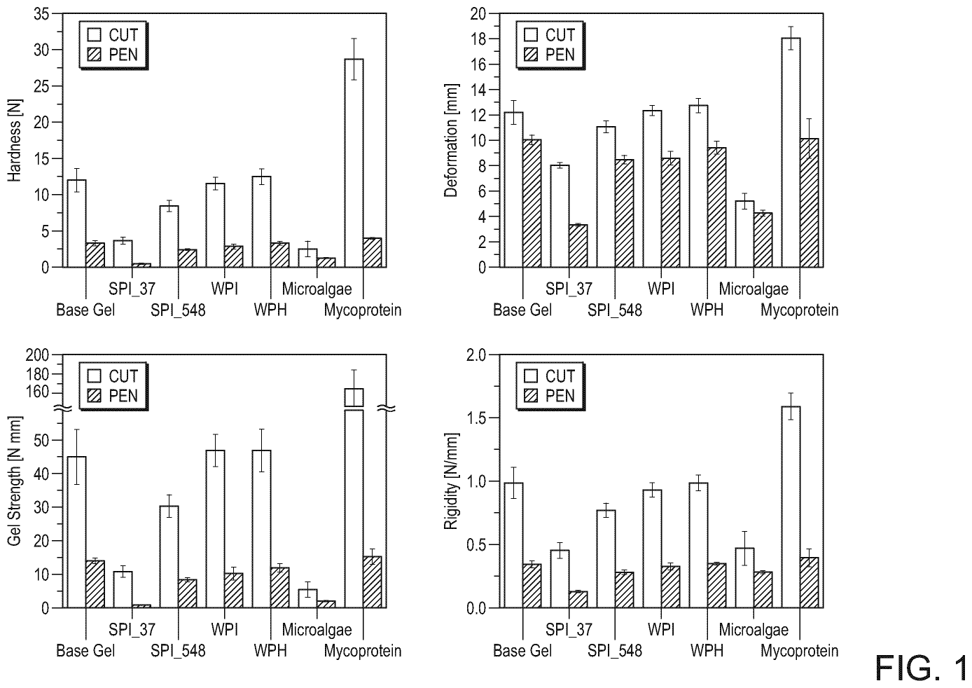

Both destructive methods CUT and PEN (FIG. 1) show significantly reduced gel strength and rigidity for the addition of SPI (SPI_37, SPI_548) to base gel, both by reducing hardness as well as deformation. Similar decrease results on the addition of microalgae Chlorella vulgaris but with an even larger decrease in deformation, promoting a more brittle gel. Whey protein hydrolysate (WPH) and whey protein isolate (WPI) do not alter hardness, deformation, gel strength and rigidity significantly in comparison to the base gel. CUT method leads to a mycoprotein gel with a 2.4 fold higher hardness (28.8 N), about 1.5 fold higher deformation (18.1 mm) and rigidity (1.6 N/mm).

All resulting in 3.6 fold higher gel strength (164.5 N), even for lower concentration of only 1.5 wt % protein addition. In contrast, PEN method shows hardness and rigidity increment to about 1.2 fold, while deformation and gel strength do not alter significantly compared with base gel.

FIG. 1 is showing texture characteristics obtained by CUT and PEN method for base gel and base gel with added protein (3 wt % protein of SPI, WPH, WPI; microalgae, 1.5 wt % mycoprotein. Bars indicate mean values with standard deviation (.Tc±sd), n=3. 10 (SPI: soy protein isolate, WPI whey protein isolate, WPH: whey protein hydrolysate, microalgae: spray dried green Chlorella vulgaris powder).

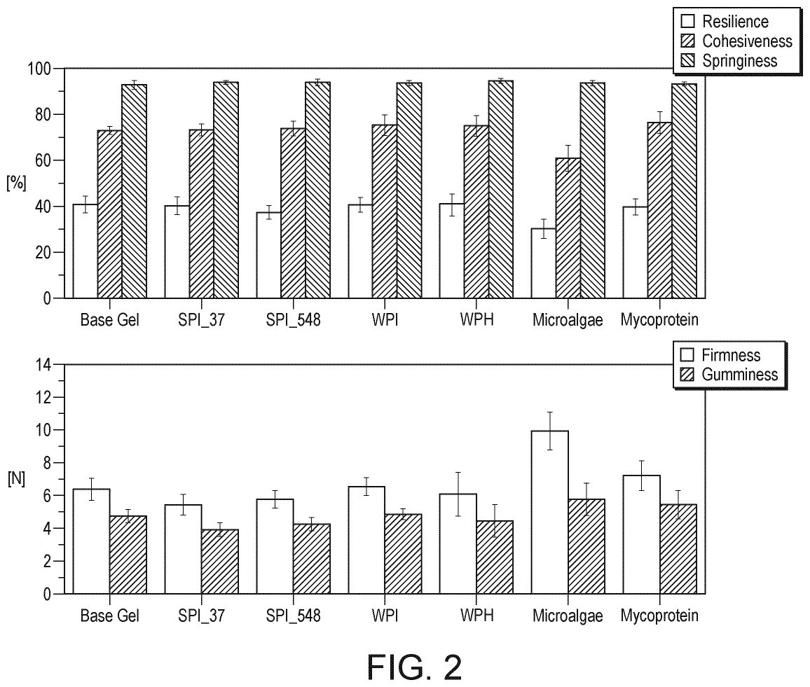

In contrast, it is difficult to differentiate between the TPA parameters (FIG. 2) for the different protein types as it was possible for parameters obtained by CUT or PEN. Firmness does not differ from base gel for all protein types except microalgae, that increases by 50%. Gumminess is reduced for SPI, while the others remain on the same value as base gel. Cohesiveness is constant at about 75% for all different proteins except microalgae, declining to 60%. The same exception applies to resilience, where microalgae drops to a value of 30%, compared to the constant level of about 40% for the other proteins as well as the reference. Springiness stays on a constant value of 93%, irrespective the gel.

Gel texture is the macroscopic consequence on gel microstructure at force application. Thus, reasons for the observed differences in the texture of the different protein gels are discussed referring to the results of microstructure investigation by microscopy. FIG. 2 shows texture characteristics obtained by TPA method for base gel and base gel with added protein (3 wt % protein of SPI, WPH, WPI; microalgae, 1.5 wt % mycoprotein). Bars indicate mean values with standard deviation (x7±sd), n=3. (SPI: soy protein isolate, WPI whey protein isolate, WPH: whey protein hydrolysate, microalgae: spray dried green Chlorella vulgaris powder).

Protein Gel Microstructure

In addition to the evaluation of textural properties of the gel, the gel microstructure was visualized by CLSM (confocal laser scanning microscopy) and cryoSEM (Cryo Scanning electron Microscopy). CryoSEM permitted visualization of the gel three-dimensional structure built by the polysaccharide network, while CLSM allowed specific imaging of protein size, shape and distribution in the gel. These two methods enabled observation of the gel inside, without destroying its original microstructure. The protein microstructure of the different protein gels was analyzed by a CLSM 710 upgraded with an Airyscan detector. Proteins were fluorescently colored by droping 10 pL of 1 w/v % Fast Green FCF on the surface of a piece of protein gel. Then, an imaging spacer 1×9×0.12 mm was positioned above a microscope slide 76×21×1 mm and the colored gel samples were placed in the center. A cover glass 24×46 mm was positioned above the spacer, in contact with the sample. Proteins could be visualized by the excitation wavelength of 633 nm and an emission wavelength of 645 nm. Image analysis was done by Zen 2.1 software.

CLSM allows to visualize fluorescently colored protein incorporated in the gel SPI_37 formed irregular polydisperse huge aggregates (>50 μm), while aggregates of SPI_548 were smaller in diameter (−20 μm) and more homogenous in size). Structure of WP I seemed similar to SPI_548, but enlarged images showed that there are zones rich in protein and other zones poor in protein. This accords to gels appearance showing white particulate aggregates incorporated in the translucent gel. Against that, initial gel translucency is not remarkably changed for WPH. This would argue for protein aggregates being smaller in sizes than the wavelength of visible light. However this is not consistent with WPH protein size determined by CLSM showing larger sizes of <10 μm. Dying can be mentioned to cause enlarged appearance in CLSM image than in real, however it cannot explain such a huge difference.

Microalgae gel showed protein as single perfectly round spheres (<3 μm) as well as clusters of these spheres that can reach diameters of >50 μm.

The structure of mycoprotein was completely different to the other protein conformations. This protein had strand-like structure, partially branched and twisted/entrapped with each other and obeys a kind of constrictions at regular intervals. Diameter of the threads can be estimated as <5 pm.

Impact of Protein Content on Gel Texture

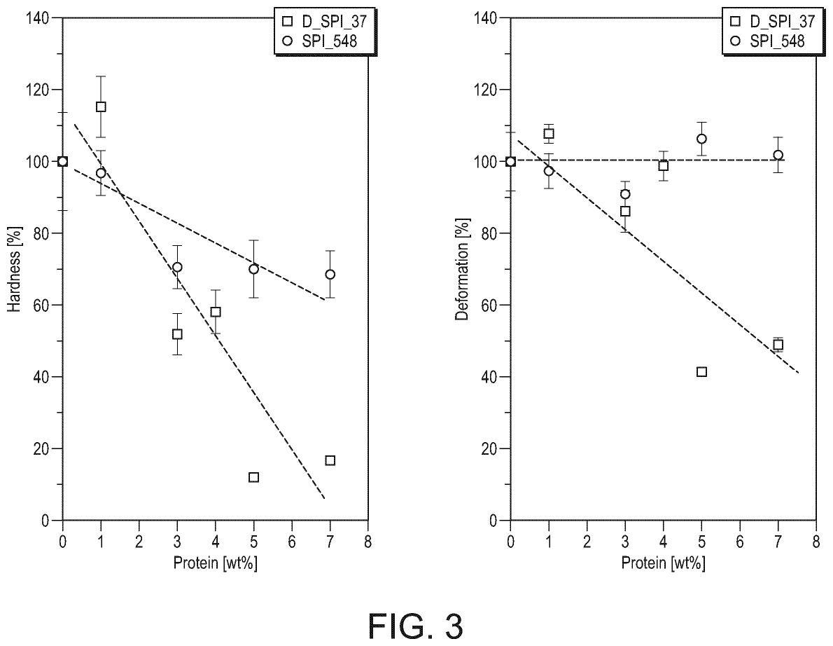

Relative hardness and deformation (base gel=0 wt % protein=100%) of D_SPI_37 (relatively larger aggregates) and SPI_548 (relatively smaller aggregates) were plotted for concentration from 0 wt % to 7 wt % (FIG. 3). FIG. 3 shows relative hardness[%] (left) and relative deformation [%] (right) for D_SPI_37 and SPI_548 plotted over protein amount added to base gel (0-7 wt %). Bars indicate standard deviation. Dotted lines are drawn to guide the eye. (SPI: soy protein isolate, D_SPI: preheated SPI, 90° C./5 min).

For both proteins an increase in concentration causes a decrease in hardness, while the effect on deformation is specific to the protein type. Hardness of SPI_548 drops by increase of protein content from 0 wt % to 3 wt % to from 100% to 70% then remained constant at further protein content increment. In contrast, there is a progressive reduction in hardness of D_SPI_37 gels as filler content increased. At 3 wt % it dropped to about 50% of initial value (0 wt % protein), further to less than 20% at 7 wt %.

Deformation of D_SPI_37 decreased at 7 wt % protein to 50% of initial value (0 wt % protein). While deformation of SPI_548 is not impacted by protein concentration and maintains at initial value for all concentrations. Interestingly an increase in gel hardness respective deformation) occurred for D_SPI_37 at a content of 1 wt % (see data >100%). Most likely the network is enhanced due to superiority of stabilizing effect by increased dry matter through protein addition to interruptive effect of particle size. Not consistent to the other trends is the maintenance of initial deformation for SPI 548 irrespective the protein content. Based on the results of deformation decline with increased aggregate size, the same should be shown for the increase in protein content, as it is the case for D_SPI_37. One approach to explain this phenomenon would be that the protein material is soft enough to be deformed similarly to the surrounding gel network, just increasing the force needed for deformation, due to higher dry matter at higher protein content. To summarize, it is possible to introduce higher amounts of protein with smaller particles, confirming involvement of both protein aggregate size and amount on gel strength. This results in two tools to adjust base gel properties by one protein type. These findings can be important to increase protein content of the gel to enlarge nutritional value.

### Example 3

Parameters Impacting Texture of Gels with Proteins—NaCl Concentration, Hydration, Heat Treatment, and Homogenization

In order to modulate the structure, respective conformation of soy protein isolate with 5 different physical treatments were selected: preheat treatment (denaturation), homogenization and a combination of both. Pre-treatments were applied on soy protein isolate dispersion, before the one-hour hydration step of the gel preparation process was started.

To preheat the soy protein isolate dispersion, the protein powder was hydrated for 30 min in water under mechanical agitation (200 rpm, magnetic stirrer IKA Ret basic C) at room temperature, followed by heating for either 5 min/1000 W or 7 min/1000 W in a microwave NN-B756B. The chosen heat treatment lead to temperature of 90° C. and 95° C., respectively. Upon cooling of the protein dispersion to room temperature in an ice water bath, the remaining dry ingredients were added to the protein dispersion and then the previously described gel preparation process in the Thermomix was started. A prolonged heat treatment was performed by heating the protein solution to 95° C. by microwave, and then transferring it into a covered pot keeping it at a similar temperature for a defined time (15 min).

In order to obtain a more homogenous size distribution of protein aggregate, soy protein dispersions of SPI_37 (heat treated) and SPI_548 (non-heat treated) were homogenized (double-pass) using a PandaPlus Homogenius 2000. A two-stage homogenization was applied with pressures of 200 bar (first stage) and 50 bar (second stage) resulting in a total pressure of 250 bar. After homogenization of the protein dispersions, the normal gel preparation process was started in the Thermomix.

The size of the protein aggregates in a 3 wt % soy protein dispersions (SPI_37, SPI_548, SPH in Vittel water) was analyzed by static light scattering with a Mastersizer 3000. The instrument has an inverse Fourier lens with an effective confocal length of 300 mm, a He—Ne red light source (A=632.8 nm) and a LED blue light source (A=470 nm). Sample addition to the Hydro MV sample dispersion unit, filled with Milli-Q water, was performed drop per drop until a laser obscuration of 5-7% was reached. A refractive index of 1.54 (proteins) and 1.33 (water) was defined. Absorption index for protein was set at 0.01 to respect irregular shape of protein aggregates. Results were calculated by the Malvem 3000 Software 21 CFR Part 11 based on Mie theory, that describes the measured particles as perfect spheres. Each sample was measured threefold, within two replicates for each protein dispersion. The volume mean diameter D[4;3] (De Brouckere mean diameter) and the volume/surface mean D[3;2] (Sauter mean diameter) were reported and averaged, as well as the Span, calculated from D90, D50 and D10, estimating the distribution width.

Effect of Heat Treatment and Homogenization on Protein Size

CLSM images were made of both SPIs with and without pre-treatment. One can observe a reduction in protein aggregate size by preheating for SPI_37, while it is difficult to differentiate between non-preheated SPI_548 and preheated SPI_548. If homogenization was applied additionally on the already preheated SPI_37 or the non-preheated D_SPI_548, one could observe a significant decrease in particle size, but also the polydispersity was reduced. Especially for homogenized D_SPI_37 the shape of protein aggregates changed to oval, which is typically for the application of shearing forces, as it happens during homogenization. In order to verify the qualitative change of protein aggregate sizes in the gel by CLSM, quantitative SLS was used to determine the aggregate sizes of corresponding protein solution.

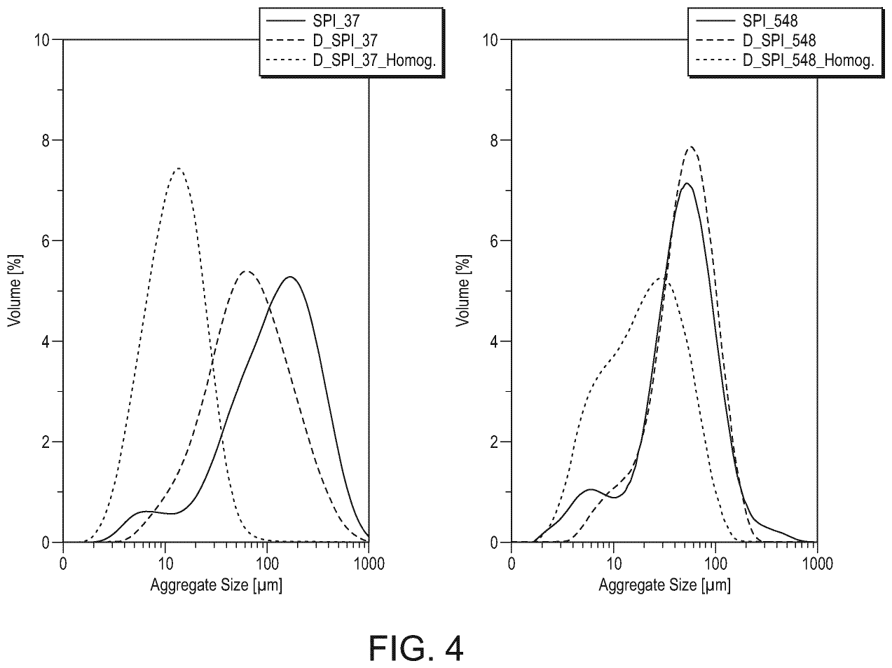

Results in Table 10 show volume and area weighted particle sizes and span, calculated from D90, D50 and D10. Additionally FIG. 4 shows volume weighted particle size distribution curve of differently pretreated SPI_37(left) and SPI_548 aqueous dispersions (right) (3 wt %). (3 wt %). (SPI: soy protein isolate, D_SPI: preheated SPI, 90° C./5 min, SPI_Homog.: homogenized SPI at 250 bar D_SPI_Homog.: preheated and homogenized SPI).

TABLE 10

| Test | Parameter | Unit | SPI_37 | D_SPL_37 | D_SPI_37_Homog. |
|---|---|---|---|---|---|
| | D[4;3] | [im] | 182.3 ± 35.0 a | 107.3 ± 47.6 b | 16.0 ± 0.50 c |
| | D[3;2] | [im] | 53.4 ± 10.8 a | 45.9 ± 9.8 a | 10.5 ± 0.31 b |
| | Span | [um] | 2.8 ± 0.29 a | 2.5 ± 0.37 a | 1.9 ± 0.08 b |
| | D90 | [im] | 389.7 ± 53.4 a | 223.9 ± 106.6 b | 29.9 ± 1.1 c |
| | D50 | [im] | 134.2 ± 29.9 a | 79.4 ± 30.5 b | 13.3 ± 0.51 c |
| | D10 | [im] | 28.1 ± 8.1 a | 20.9 ± 3.1 a | 5.4 ± 0.11 c |
| | | | SPI_548 | D_SPI_548 | D_SPI_548_Homog. |
| | D[4;3] | [im] | 64.5 ± 4.0 a | 63.5 ± 1.8 a | 29.5 ± 0.60 b |
| | D[3;2] | [im] | 26.0 ± 0.32 a | 37.1 ± 3.1 b | 13.9 ± 1.4 c |
| | Span | [im] | 2.2 ± 0.12 a | 1.9 ± 0.13 b | 2.7 ± 0.17 c |
| | D90 | [im] | 123.2 ± 4.3 a | 119.0 ± 3.2 a | 64.1 ± 0.29 b |
| | D50 | [im] | 50.8 ± 1.4 a | 55.2 ± 2.1 b | 21.9 ± 1.1 c |
| | D10 | [im] | 12.0 ± 0.58 a | 18.8 ± 2.7 b | 5.9 ± 0.74 c |

Different letters (a, b, c) in the same row indicate significant differences between means (P < 0.05).
(SPI: soy protein isolate. D_SPI: preheated SPI, 90° C./5 min. SPI_Homog.: homogenized SPI at 250 bar D_SPI_Homog.: preheated and homogenized SPI).

For both SPIs a shift to smaller scaled particles by homogenization can be identified, proving qualitative trend detected by CLSM images. Similar shift direction is observed for SPI_37, if preheating was applied (see curve for D_SPI_37). Heat application tends to induce a disaggregation of the soy protein aggregates. Against that, no significant 10 change in mean volume diameter (Table 10) as well as no remarkable shift of distribution curve is recorded for SPI_548. Both quantitative findings correspond to qualitative CLSM observations.

Correlation of Protein Aggregate Size and Textural Parameters

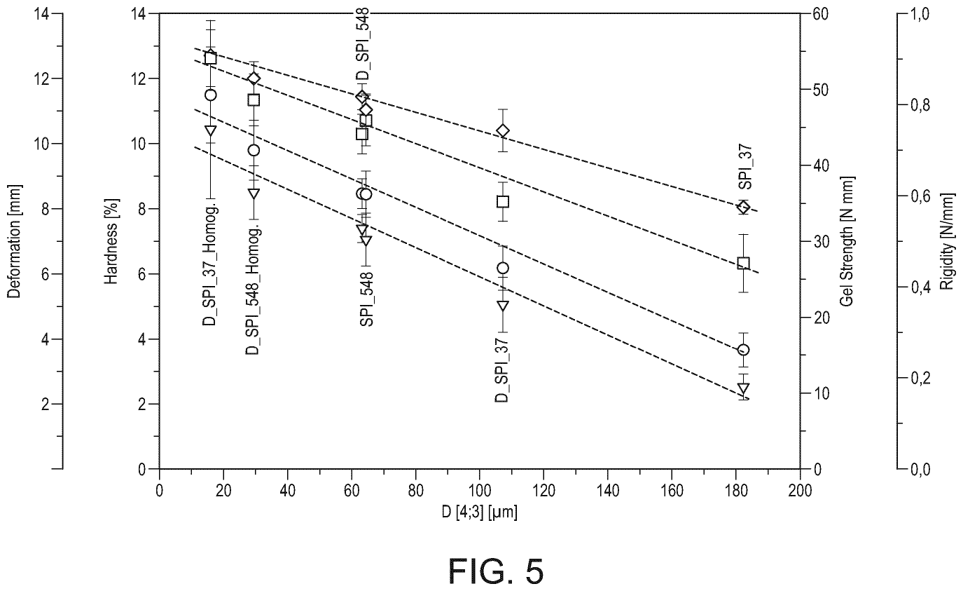

15 To summarize, both physical treatment methods are successful to reduce protein aggregate size. This in turn allows to control gel strength, as it hypothetically depends on filler particle size. In order to test this hypothesis hardness and deformation, gel strength and rigidity were plotted against the respective particle size for both non preheated, preheated and homogenized SPIs (FIG. 5).

FIG. 5 shows a correlation of volume mean D[4,3] of differently pretreated SPI_37 and SPI_548 aqueous dispersions (3 wt %) and textural parameters hardness, deformation, gel strength and rigidity. Bars indicate standard deviation. Dotted lines are drawn to guide the eye. (3 wt %). (SPI: soy protein isolate, D_SPI: preheated SPI, 90° C./5 min, SPI_Homog.: homogenized SPI at 250 bar D_SPI_Homog.: preheated and homogenized SPI).

A linear correlation of D[4,3] and textural parameters was found. The dotted lines in the figure are drawn to guide the eye. The smaller the protein aggregates, the higher gel strength of protein filled gels or vice versa, the less base gel is interrupted/weakened. Same argues for increased deformation. Deformation of higher cross-linked gel network (due to smaller voids(protein)) can withstand deformation to a longer extend.

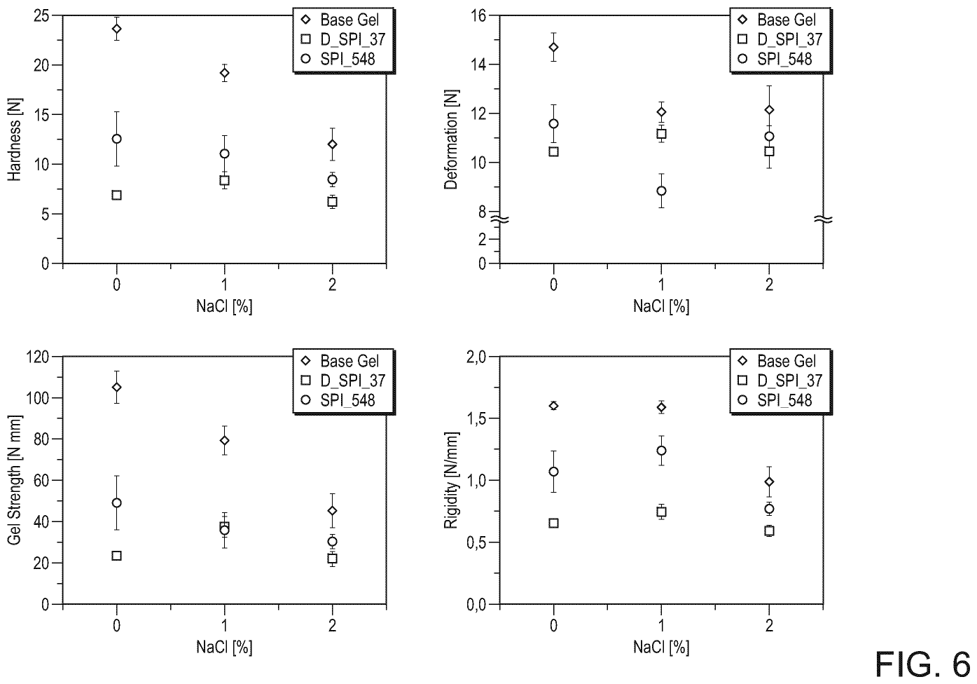

Effect of NaCl content on base gel and protein containing base gel Studies on impact of NaCl concentration (0, 1, 2 wt %) on base gel and gels with protein were performed, adjusting base gel formulations (Table 7) and calculating protein and water content as previously described. Direct NaCl (and KCl) addition on a level of 2 wt % (respectively 0.3 wt %) to the protein solution affects precipitation of protein. the impact of NaCl was selected to be studied by variation of salt content of base gel and respective protein gels. FIG. 6 shows hardness, deformation, gel strength and rigidity for base gel, D_SPI_37 and SPI_548 plotted over NaCl concentration.

In particular, it shows texture characteristics obtained by CUT method for base gel, D_SPI_37 and SPI_548 prepared at different concentrations of NaCl (0 wt %, 1 wt %, 2 wt %). Bars indicate standard deviation. (SPI: soy protein isolate, D_SPI: preheated SPI, 90° C./5 min). Base gels initial hardness is doubled at a reduction of NaCl content from 2 wt % to 0 wt % from 12 N to 24 N. Similar doubling is obtained for gel strength, while deformation only rises from about 12 mm to 15 mm, also rigidity increment is less. That means base gel gets stronger by a huge rise in hardness and a moderate rise in deform ability respective elasticity with decreasing NaCl content.

### Example 4

Vegan Salmon Analogue Preparation

The vegan salmon analogue was prepared according to the following recipe in Table 11:

| Ingredients | % |
|---|---|
| Konjac Powder (YZ-CH-35) (GM > 95) | 0.8 |
| Carrageenan | 0.7 |
| Potato fiber | 0.4 |
| Potassium Chloride (KCl) | 0.3 |
| NaCl | 1.2 |
| Sucrose | 0.5 |
| Soy protein isolate | 2 |
| Salmon flavor | 0.3 |
| DHA oil from algae | 0.2 |
| Orange colorant | 0.4 |
| Water (Vittel) | 93.2 |

The orange layer was prepared by first preheating protein to make small aggregates. Proteins are suspended in water and hydrated for 30 min at room temperature with mixing. The suspension was heated to 85° C. for 15 min and then cooled down to 20 to 40° C. Konjac powder, carrageenan, potato fiber, KCl, NaCl, and sucrose are added in the preheated protein suspension, keeping agitation for 1 h at room temperature. This serves to hydrate the fibers with salts. The mixture was then heated at 85° C. for 15 min with constant stirring to solubilize the fibers. It was important that the mixing was not too strong, otherwise there was phase separation and too much foaming. Flavors, DHA oil, and then colors are added and well mixed. The mixture was then kept at 80° C. for molding.

The white layer was prepared by white insoluble fibers in dry powder format. Emulfiber which comprises bamboo fiber, carrot fiber, psyllium husk was used. A 15% calcium carbonate suspension was then prepared with water, preheated and cooled down.

For the molding step, the orange paste (held at temperature of 80° C.) was added to a 1 cm thick mold. A thin layer of white powder was sprinkled on the hot surface of the first orange layer. This had to be done while the surface was hot. The calcium carbonate suspension was sprayed on the white powder to slightly hydrate the powders. Another layer of orange paste was poured on top. The layering was repeated until there were more than 5 orange layers. The final layer was an orange layer. The orange paste needed to be hot (65° C. to 85° C.) for the layering. The gel was then cooled down at room temperature for 30 min and then stored in fridge.

The following gel samples were prepared as per Table 12:

| Sample number | Name | Description |
|---|---|---|
| 1 | Reference | No protein |
| 2 | SPI | soy protein isolate |
| 3 | WPH | whey protein hydrolysate |
| 4 | Chlorella | Chlorella vulgaris |
| 5 | Mycoprotein A | homogenization level 2/5 min |
| 6 | Mycoprotein B | homogenization level 5/5 min |
| 7 | WPI | whey protein isolate |
| 8 | KC | 0.8% Carrageenan |
| 9 | KC | 0.4% Carrageenan |

For sample numbers 2 to 7, the protein gel comprised 3% protein (based on protein content of protein source). For sample numbers 8 and 9, the protein gel comprised 2% protein.

For gel preparation, the mixtures were first hydrated for 1 hour and then heated to 85° C. for 15 min (Thermom ix). The resulting gels were molded and cooled at room temperature. Measurements were made on day 1 at room temperature.

TABLE 13

| Ingredient | g/100 g water | % |
|---|---|---|
| Konjac Glucomannan | 0.52 | 0.50 |
| Carrageenan | 0.41 | 0.40 |
| Potato fiber | 0.41 | 0.40 |
| NaCl | 2.07 | 2.00 |
| KCl | 0.31 | 0.30 |
| Water | 100.00 | 96.40 |

TABLE 14

| Ingredient | Amount % |
|---|---|
| Carrageenan | 0.80/0.40 |
| Potato fiber | 0.40 |
| NaCl | 2.00 |
| KCl | 0.30 |
| Water | 92.90/93.30 |
| Protein | 2.00 |
| Sucrose | 0.50 |
| High oleic sunflower oil | 0.20 |
| white fish flavor | 0.20 |
| Color | 0.20 |
| | 100.00 |

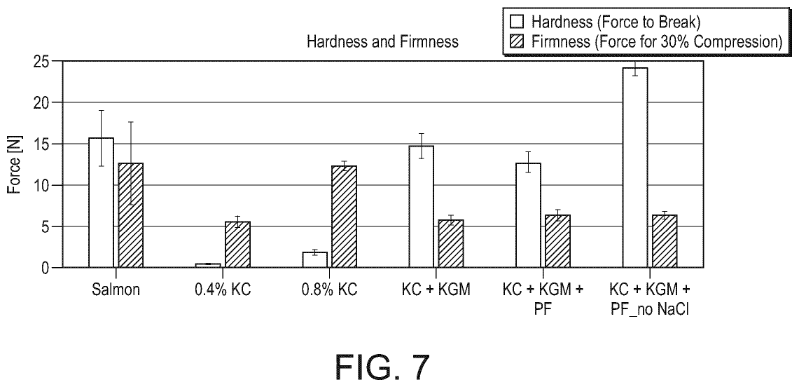

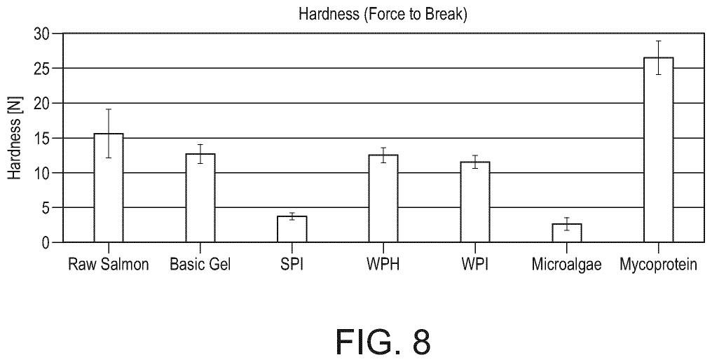

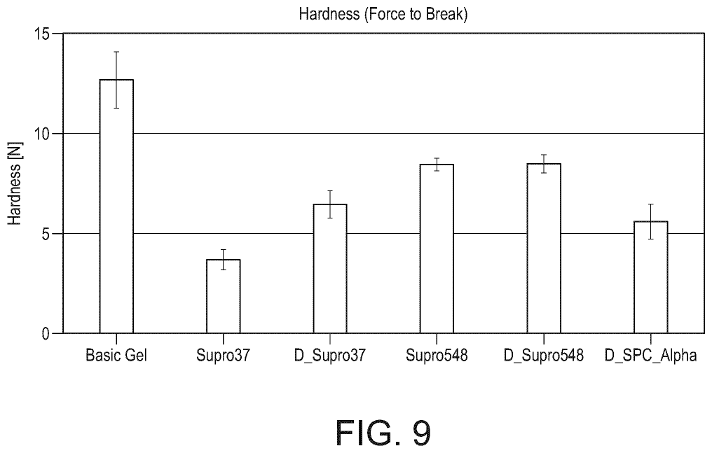

A penetration test was performed to test the different effects of Kappa-carrageenan (KC), Konjac glucomannan (KGM), and potato fiber (PF). The results are shown in FIG. 7, and can be summarized as follows:

| Fiber mix | Result |
|---|---|
| KC only | brittle, non-elastic gels, easy to fracture, low gel strength |
| KC/KGM | increased viscosity supports gel strength, |
| | increases resistance to fracture |
| KC/KGM/PF | PF decreases hardness, deformation (elasticity), gel strength |

1. A method of preparing a salmon analogue, said method comprising the steps of:
Hydrating a mixture comprising a plant protein source, a glucomannan source, a carrageenan source, and a potassium salt;
Heating the mixture; and
Cooling the mixture to less than 80° C. to form a first layer.

2. The method according to claim 1, wherein the first layer comprises up to 10 wt % plant protein source.

3. The method according to claim 1 wherein the plant protein is selected from soy protein, whey protein, microalgae, and mycoprotein.

4. The method according to claim 1, wherein the first layer comprises between 0.3 to 1 wt % carrageenan source.

5. The method according to claim 1, wherein the first layer comprises between 0.5 to 1.5 wt % glucomannan source.

6. The method according to claim 1 wherein the glucomannan source is konjac glucomannan.

7. The method according to claim 1, wherein the first layer further comprises sodium chloride (NaCl).

8. The method according to claim 1 wherein the mixture is hydrated for at least 30 minutes.

9. The method according to claim 1, wherein the mixture is pH 6 or greater.

10. The method according to claim 1 wherein the mixture is heated to at least 75° C.

11. The method according to claim 1, wherein the insoluble fiber source in the second layer comprises over 80 wt % insoluble fiber.

12. The method according to claim 1, wherein the insoluble fiber source in the second layer is bamboo fiber, wheat fiber, oat fiber, cellulose powder, and mixtures thereof.

13. The method according to claim 1, wherein the insoluble fibre source in the second layer has a D90 particle size between 60 to 200 μm.

14. The method according to claim 1, wherein the calcium salt in the second layer is calcium carbonate, calcium sulphate, calcium phosphate, and tricalcium citrate.

15. A salmon analogue comprising a first layer and a second layer, wherein the first layer comprises plant protein, a glucomannan source, a carrageenan source, a potassium salt, a sodium salt, and the second layer comprises an insoluble fiber source and a calcium salt.

16. The salmon analogue according to claim 15, wherein said salmon analogue comprises less than 30 calories per 100 g.

17. The salmon analogue according to claim 15, wherein the plant protein source is denatured, hydrolyzed and homogenized.
